(19) United States
(12) Patent Application Publication
(10) Pub. No.: US 2014/0103271 A1
(43) Pub. Date: Apr. 17, 2014

(54) HEAT RAY SHIELDING COMPOSITION

(71) Applicant: MITSUBISHI MATERIALS CORPORATION, Tokyo (JP)

(72) Inventors: Ai Takenoshita, Naka-shi (JP); Takehiro Yonezawa, Naka-shi (JP); Kazuhiko Yamasaki, Naka-shi (JP)

(73) Assignee: MITSUBISHI MATERIALS CORPORATION, Tokyo (JP)

(21) Appl. No.: 14/051,755

(22) Filed: Oct. 11, 2013

(30) Foreign Application Priority Data
Oct. 15, 2012 (JP) 2012-227618

(51) Int. Cl. G02B 1/10

(52) U.S. Cl. CPC G02B 1/10
USPC 252/587

(57) ABSTRACT

To provide a heat ray shielding composition having a high transmittance of visible light rays and a high cut rate of near-infrared rays. The heat ray shielding composition of the invention is constituted by mixing one or two or more near-infrared ray-absorbing pigments selected from a group consisting of diimonium-based pigments, phthalocyanine-based pigments and dithiol metal complex pigments in a dispersion liquid formed by dispersing ITO powder in a range of 0.1 mass % to 50 mass % in a range of 0.01 mass to 0.5 mass % with respect to 100 mass % of the dispersion liquid. The ITO powder is used in manufacturing an ITO film which has a band gap in a range of 4.0 eV to 4.5 eV.

### TECHNICAL FIELD

The present invention relates to a heat ray shielding composition which has a high transmittance of visible light rays and a high cut rate of near-infrared rays and includes ITO powder, and, more specifically, to a heat ray shielding composition preferable as a raw material of an infrared ray-absorbing paint. In the present specification, ITO refers to an indium tin oxide.

### BACKGROUND ART

In the past, an ITO film was an optical film for which ITO particles were used, had a band gap of approximately 3.75 eV, and had a high transparency in a visible light range (for example, refer to Patent Document 1). Therefore, the ITO film has been widely used in fields in which excellent optical characteristics are required, such as a transparent electrode in a liquid crystal display (for example, refer to Patent Document 2) or a heat ray shielding material having a high heat ray shielding effect (for example, refer to Patent Document 3). For the high transparency in the visible light range and the heat ray shielding effect, paint, including ITO (hereinafter referred to as ITO paint) is preferably used in building glass or car glass. Therefore, a recent request for energy saving in the summer creates a demand for this type of paint, particularly, a heat ray shielding composition that composes the paint to have a high transmittance of visible light rays and a high cut rate of near-infrared rays.

### RELATED ART DOCUMENT

### Patent Document

[Patent Document 1] Japanese Unexamined Patent Application. No. 2009-032699 (paragraph [0009])
[Patent Document 2] Japanese Unexamined Patent Application. No. 2005-054273 (paragraph [0006])

[Patent Document 3] Japanese Unexamined Patent Application No. 2011-116623 (paragraph [0002])

### DISCLOSURE OF THE INVENTION

### Problem that the Invention is to Solve

In the related art, there was no ITO paint, in other words, there was no heat ray shielding composition included in the paint which satisfied the above demand for having both characteristics of a high transmittance of visible light rays and a high cut rate of near-infrared rays.

An object of the invention is to provide a heat ray shielding composition having a high transmittance of visible light rays and a high cut rate of near-infrared rays. In addition, another object of the invention is to provide an ITO paint including the heat ray shielding composition.

### Means for Solving the Problems

According to a first aspect of the invention, there is provided a heat ray shielding composition constituted by mixing one or two or more near-infrared ray-absorbing pigments selected from a group consisting of diimonium-based pigments, phthalocyanine-based pigments and dithiol metal complex pigments in a dispersion liquid formed by dispersing ITO powder in a range of 0.1 mass % to 50 mass % in a range of 0.01 mass % to 0.5 mass % with respect to 100 mass % of the dispersion liquid, in which the ITO powder is used in manufacturing an ITO film which has a band gap in a range of 4.0 eV to 4.5 eV.

In addition, according to a second aspect of the invention, there is provided an ITO paint including the heat ray shielding composition according to the first aspect, which is the invention of the first aspect, a binder and a solvent.

In addition, according to a third aspect, there is provided a method for forming a heat ray shielding film by coating the ITO paint according to the second aspect on a transparent base material.

Furthermore, according to a fourth aspect, there is provided a method for forming a heat ray shielding film by uniformly mixing the heat ray shielding composition according to the first aspect with film forming composition, and forming a film using a mixture.

### Advantage of the Invention

In the heat ray shielding composition according to the first aspect of the invention, since the ITO powder used in manufacturing an ITO film which is transited to a higher energy side than an optical band gap in the related art of approximately 3.75 eV is used as a raw material, it is possible to increase the transmittance of visible light rays, and, since the near-infrared ray-absorbing pigments are mixed, it is possible to increase the cut rate of near-infrared rays. Specifically, the heat ray shielding composition of the invention has a transmittance of visible light rays of 90% or more, a transmittance of near-infrared rays of 55% or less at a wavelength of 900 nm, a transmittance of near-infrared rays of 16.5% or less at a wavelength of 1100 nm and a transmittance of near-infrared rays of 0.4% or less at a wavelength of 1300 nm.

Since the ITO paint according to the second aspect of the invention exhibits a high transmittance of visible light rays or a high cut rate of near-infrared rays when coated on building glass or car glass, it is possible to suppress an increase in a temperature in a building or a car in a state in which an inside of the building or the car is made to be bright in summer.

When the ITO paint according to the second aspect is coated on building or car glass or surfaces of a variety of films using the method according to the third aspect of the invention, it is possible to more easily form a heat ray shielding film.

When the heat ray shielding composition according to the first aspect is incorporated into the film forming composition, and the mixture is formed into a film using the method according to the fourth aspect of the invention, it is possible to more easily form a film having a heat ray shielding effect.

### BEST MODE FOR CARRYING OUT THE INVENTION

Next, a best mode for carrying out the invention will be described. The heat ray shielding composition of the invention is constituted by dispersing one or two or more near-infrared ray-absorbing pigments selected from a group consisting of diimonium-based pigments, phthalocyanine-based pigments and dithiol metal complex pigments in a dispersion liquid of ITO powder used in manufacturing an ITO film which has a band gap in a range of 4.0 eV to 4.5 eV, and preferably, 4.0 eV to 4.35 eV. When the band gap is less than 4.0 eV, the transmittance in the visible light range does not sufficiently improve, and the upper limit value of the band gap of 4.5 eV is the maximum value that can be achieved using current techniques. The ITO powder used in manufacturing an ITO film has a dark blue hue (L*=30 or less, a*<0, b*<0 in L*a*b* color system). When the optical characteristics are measured using a glass cell having an optical path length of 1 mm, a heat ray shielding composition obtained by dispersing the above near-infrared ray-absorbing pigments in a dispersion liquid in which the ITO powder is dispersed in a concentration range of 0.7 mass % to 1.2 mass % has a heat ray shielding effect in which the transmittance of visible light rays is 90% or more, the transmittance of near-infrared rays at a wavelength of 900 nm is 55% or less, the transmittance of near-infrared rays at a wavelength of 1100 nm is 16.5% or less and the transmittance of near-infrared rays at a wavelength of 1300 nm is 0.4% or less.

The ITO powder used in manufacturing an ITO film of the invention is ITO powder having modified surfaces which is manufactured using the following four methods. The transmittance of the heat ray shielding composition manufactured using the ITO powder in the visible light range can be increased by modifying the surfaces of the ITO powder.

<Method for Manufacturing the ITO Powder>

(1) First Manufacturing Method

A trivalent indium compound and a divalent tin compound are precipitated in a solution in the presence of an alkali, and generate a co-precipitated hydroxide of iridium and tin. At this time, when the solution is adjusted to 4.0 to 9.3 and preferably 6.0 to 8.0 in pH and to 5° C. or higher and preferably 10° C. to 80° C. in temperature, co-precipitated hydroxide of indium and tin, dried powder of which has a hue from bright yellow to yellowish red, can be precipitated. The hydroxide having a hue from bright yellow to yellowish red is superior to white indium tin hydroxide of the related art in terms of crystallinity. In order to adjust the liquid properties during a reaction to a pH between 4.0 to 903, for example, it is preferable to use a mixed aqueous solution of indium trichloride (InCl₃) and tin dichloride (SnCl₂.2H₂O) and to add the mixed aqueous solution and an alkali aqueous solution dropwise to water at the same time so as to adjust the pH in the above range. Alternatively, the liquid mixture is added dropwise to an alkali aqueous solution. As the alkali aqueous solution, ammonia (NH₃) water, ammonium hydrogen carbonate (NH₄HCO₃) water or the like can be used.

After the co-precipitated indium tin hydroxide is generated, the precipitate is washed using pure water until the resistivity of a supernatant liquid becomes 5000 Ω·cm or more and preferably 50000 Ω·cm or more. When the resistivity of the supernatant liquid is lower than 5000 Ω·cm, impurities such as chlorine are not sufficiently removed, and high-purity indium tin oxide powder cannot be obtained. The supernatant liquid of the precipitate having a resistivity of 5000 Ω·cm or more is removed so as to make the precipitate into a highly viscous slurry form, and ultraviolet rays in a range of 126 nm to 365 nm are radiated for 1 hour to 50 hours while stirring the slurry. When the wavelength of the ultraviolet ray is less than the lower limit value, it is not possible to use a generally-used ultraviolet radiator, and, when the wavelength exceeds the upper limit value, the precipitate does not sufficiently absorb ultraviolet rays, it becomes impossible to obtain the effect of radiating ultraviolet rays. When the radiation time is less than the lower limit value, the ultraviolet absorption of the precipitate is poor, and it becomes impossible to obtain the effect of radiating ultraviolet, rays, and the effect cannot be obtained even when ultraviolet rays beyond the upper limit value are radiated.

After ultraviolet rays are radiated, the slurry-form indium tin hydroxide is dried in the atmosphere, preferably in an inert gas atmosphere such as nitrogen or argon, at 100° C. to 200° C. for 2 hours to 24 hours, and fired in the atmosphere at 250° C. to 800° C. for 0.5 hours to 6 hours. An aggregate formed through the firing is pulverized and raveled using a hammer mill, a ball mill or the like, thereby obtaining ITO powder. When the ITO powder is put and impregnated into a surface treatment agent obtained by mixing 50 parts by mass to 95 parts by mass of dehydrated ethanol and 5 parts by mass to 50 parts by mass of distilled water, then, put into a glass petri dish, and heated in a nitrogen gas atmosphere at 200° C. to 400° C. for 0.5 hours to 5 hours, ITO powder having modified surfaces can be obtained.

(2) Second Manufacturing Method

After the supernatant liquid of the precipitate which is the indium tin co-precipitated hydroxide obtained using the first manufacturing method is removed so as to obtain a slurry-form indium tin hydroxide, the slurry-form indium tin hydroxide is gasified using ultrasonic waves of 40 kHz to 2 MHz in a state in which N₂ gas, which is a carrier gas, is circulated in a tube-like furnace that is disposed perpendicularly to the longitudinal direction of a tube and heated to 250° C. to 800° C., and sprayed to the circulating N₂ gas. When the frequency of the ultrasonic waves is less than the lower limit value, since droplets including atomized indium tin hydroxide are large, and the content of the indium tin hydroxide in the droplets is large, there is a disadvantage that ITO is sintered and coarsened during thermal decomposition, and, when the frequency exceeds the upper limit value, there is a disadvantage that the atomizing efficiency becomes poor. Therefore, the indium tin hydroxide is thermally decomposed in the tube-like furnace, and ITO powder having modified surfaces is obtained from the outlet of the tube-like furnace.

(3) Third Manufacturing Method

After the supernatant liquid of the precipitate which is the indium tin co-precipitated hydroxide obtained using the first manufacturing method is removed so as to obtain a slurry-form indium tin hydroxide, the indium tin hydroxide is dried in the atmosphere, preferably in an inert gas atmosphere such as nitrogen or argon, at 100° C. to 200° C. for 2 hours to 24 hours, thereby obtaining indium tin hydroxide powder. Laser rays are radiated on a dispersion solution of the indium tin hydroxide powder. The type of laser that can be used in the method is not limited as long as the laser can generate a high-intensity pulse light, and examples thereof include Nd:YAG laser, excimer laser and Ti sapphire laser, and Nd:YAG laser is preferable. The radiation intensity of the laser rays is not limited as long as the indium tin hydroxide in the solution is irradiated with the laser rays and can be ablated, and 10 mJ (10 mJ/pulse) or more is sufficient as the intensity per pulse, and 50 mJ/pulse to 500 mJ/pulse is desirable. In addition, the pulse width of the laser rays is not limited, but is preferably 1 nm to 20 ns, and the peak power is preferably 0.5 MW to 500 MW. In addition, the oscillation frequency (pulse cycle) of the laser is not limited, but is preferably 10 Hz to 60 Hz, and the average powder is preferably 0.1 W to 30 W.

In the method, it is possible to use water or an organic solvent such as an alcohol or hexane as a solvent of the solution, and the solvent is not particularly limited. Preferably, the solvent is desirably a liquid that does not strongly absorb light at the wavelength of the laser rays being radiated. For example, in a case in which Nd:YAG laser rays having a wavelength of 266 nm to 1.064 nm are used, deionized water, ethanol, methanol, butanol, isopropyl alcohol and propyl alcohol are preferable. In addition, it is possible to add a variety of surfactants or substances such as metal salts, acids and alkalis to the solution as additives, and the substances are not limited as long as the substances are fully dissolved in the solution. Similarly to the solution, it is particularly desirable to use substances that do not strongly absorb light at the wavelength of the laser rays being radiated. For example, in a case in which Nd:YAG laser rays having a wavelength of 266 nm to 1064 nm are used, additives such as amphoteric surfactants, cationic surfactants and anionic surfactants are preferably used.

The wavelength of the laser rays is not particularly limited in a case in which deionized water is used as the solvent of the solution, but is preferably 266 nm to 1064 nm. In a case in which an organic solvent or a surfactant is used, the wavelength is desirably a wavelength at which the laser rays are not strongly absorbed by the organic solvent or the surfactant, and more preferably 355 nm to 1064 nm. For example, in the case of deionized water or an alcohol such as ethanol, methanol, butanol, isopropyl alcohol or propyl alcohol, the fundamental wave (wavelength: 1.064 nm), second harmonic wave (wavelength: 532 nm), third harmonic wave (wavelength: 355 nm), fourth wave (wavelength: 266 nm) and the like of Nd:YAG layer having a nano-second pulse width can be used.

More desirably, the laser rays are radiated through a condensing lens; however, in a case in which the intensity of the laser rays is sufficiently strong, it is also possible to remove the condensing lens. The focal distance of the condensing lens being used is preferably 50 cm to 3 cm, and more preferably 10 cm to 5 cm. In addition, the focal, point of the laser rays may be present in the vicinity of the surface of the liquid, and particularly desirably in the liquid. The concentration of the ITO powder dispersed in the solution is preferably g/L or less, desirably 0.02 g/L or less, and particularly desirably 0.005 g/L to 0.01 g/L.

The indium tin hydroxide is dissociated in the solution in forms of atoms, ions and clusters due to laser ablation, and then reacted in the solution so that the average particle diameter becomes smaller than that of an indium tin hydroxide before the laser radiation, thermal decomposition occurs, and ITO nanopowder is formed. The occurrence of ablation in the solution can be confirmed using, for example, light emission from ablation plasma.

A container to be filled with the ITO powder dispersion liquid can be appropriately selected from the materials, shapes and the like of well-known containers. In addition, during the radiation of the layer rays, the ITO powder dispersion liquid is preferably stirred using stirring means installed at the bottom portion of the container. Well-known stirring means can be used as the stirring means, and examples thereof include a TEFLON (registered trademark) rotor provided using a magnetic stirrer and the like. The stirring rate is not particularly limited, but is preferably 50 rpm to 500 rpm. In addition, the temperature of the ITO powder dispersion liquid immediately before the radiation of the laser rays is preferably 20° C. to 35° C. In addition, the temperature of the solution during the laser radiation is preferably 25° C. to 40° C.

When the laser rays are radiated under the above conditions, and then the ITO nanopowder is observed using a transmission electron microscope, the average particle diameter of the powder in the laser-radiated TTO nanopowder dispersion solution is preferably 1 nm to 30 nm, and more preferably 2 nm to 15 nm. In addition, when the crystallinity of the laser-radiated ITO nanopowder is evaluated using electron beam diffraction, there are cases in which amorphized ITO nanopowder is obtained depending on the laser radiation conditions. As such, when a solution in which the ITO nanopowder obtained after the laser radiation has been dispersed is solid-liquid separated and dried, ITO powder having modified surfaces can be obtained.

(4) Fourth Manufacturing Method

After the supernatant liquid of the precipitate which is the indium tin co-precipitated hydroxide obtained using the first manufacturing method is removed so as to obtain a slurry-form indium tin hydroxide, the indium tin hydroxide is dried in the atmosphere, preferably in an inert gas atmosphere such as nitrogen or argon, at 100° C. to 200° C. for 2 hours to 24 hours, and then fired in the atmosphere at 250° C. to 800° C. for 0.5 hours to 6 hours. An aggregate formed through the firing is pulverized and raveled using a hammer mill, a ball mill or the like, thereby obtaining ITO powder. A pulverization treatment is carried out on the ITO powder using a jet mill so as to make the average particle diameter in a range of 5 nm to 15 nm. Subsequently, similarly to the first method, when the ITO powder is put and impregnated into a surface treatment agent obtained by mixing dehydrated ethanol and distilled water, then, put into a glass petri dish, and heated in a nitrogen gas atmosphere, ITO powder having modified surfaces can be obtained.

Meanwhile, in the specification, the average particle diameter of the ITO powder refers to the average particle diameter based on the number distribution, and, in the invention, is the average diameter of 200 powder particles.

Next, a method for manufacturing the heat ray shielding composition of the invention, in which the ITO powder manufactured using the above method is used, will be described.

<Method for Manufacturing the Heat Ray Shielding Composition>

First, the ITO powder manufactured using the above method is dispersed in a liquid such as methyl ethyl ketone, toluene, xylene or isopropyl alcohol so as to prepare an ITO dispersion liquid. The concentration of the ITO powder in the ITO dispersion liquid is adjusted in a range of 0.1 mass % to 50 mass % and preferably 0.3 mass % to 30 mass %. When the concentration of the ITO powder is less than the lower limit value, sufficient heat ray cutting characteristics cannot be obtained, and, when the concentration exceeds the upper limit value, there is a disadvantage that the transmittance of visible light rays decreases. Next, one or two or more near-infrared ray-absorbing pigments selected from group consisting of diimonium-based pigments, phthalocyanine-based pigments and dithiol metal complex pigments are added to the ITO dispersion liquid in a range of 0.01 mass % to 0.5 mass %, and preferably 0.05 mass % to 0.3 mass % with respect to 100 mass % of the dispersion liquid, and uniformly mixed. When the content is less than the lower limit value, the cut rate of near-infrared rays is not sufficiently high, and, when the content exceeds the upper limit value, there is a disadvantage that the transmittance of visible light rays decreases. Meanwhile, the heat ray shielding composition having a concentration of the ITO powder in the above range may be manufactured by mixing the near-infrared ray-absorbing pigment powder with the dispersion medium in the beginning, and then mixing the ITO dispersion liquid having a high concentration of the ITO powder with the liquid mixture. Here, the near-infrared rays refer to electromagnetic waves having a wavelength in a range of approximately 700 nm to 2500 nm.

Examples of the diimonium-based pigments include CIR-1080, CIR-1081, CIR-1083 manufactured by Japan Carlit Co., Ltd., Epolight1117 manufactured by Epolin, Inc., IRG-022, TRG-023, IRG-040 manufactured by Nippon Kayaku Co., Ltd., and the like.

In addition, the phthalocyanine-based pigment is specifically a pigment represented by the following formula (1), and examples thereof include PROJET 800NP, 830NP, 900NP, 925NP manufactured by Avecia Biotechnology Inc., EXCOLOR IR-10A, IR-12, IR-14, 906B, 910B manufactured by Nippon Shokubai Co., Ltd., and the like.

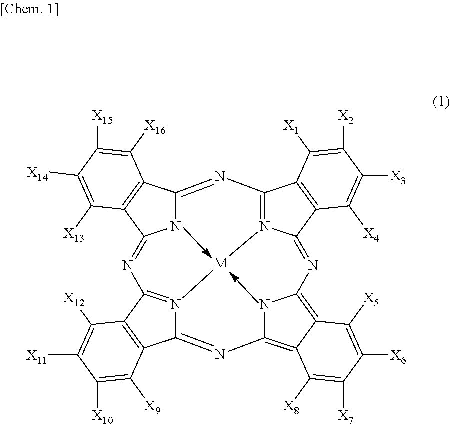

In the formula, X₁ to X₁₆ independently represent a hydrogen atom, a halogen atom, —SR¹ or —OR², —NHR³; each of R¹, R² and R³ independently represents a phenyl group which may have a substituent or an alkyl group having 1 to 20 carbon atoms, and M represents a metal-free element, a metal, a metallic oxide or a metal halide.

The center M of a phthalocyanine complex represents a metal-free element, a metal, a metallic oxide or a metal halide. The metal-free element refers to a non-metallic atom, for example, two hydrogen atoms. Examples of the metal include iron, magnesium, nickel, cobalt, copper, palladium, zinc, vanadium, titanium, indium, tin and the like. Examples of the metallic oxide include titanyl, vanadyl and the like. Examples of the metal halide include aluminum chloride, indium chloride, germanium chloride, tin (II) chloride, tin (IV) chloride, silicon chloride and the like. M is preferably a metal, a metallic oxide or a metal halide, and specifically is copper, zinc, cobalt, nickel, iron, vanadyl, titanyl, indium chloride or tin (II) chloride.

Examples of the phenyl group having a substituent include a phenyl group substituted by 1 to 3 alkyl groups having 1 to 4 carbon atoms, a phenyl group substituted by 1 to 2 alkoxy groups having 1 to 4 carbon atoms and a phenyl group substituted by 1 to 5 halogen atoms such as chlorine or fluorine.

furthermore, the dithiol metal complex-based pigment is specifically a pigment represented by the following formula (2), and examples thereof include Epolight3063, Epolight4019, Epolight4121, Epolight4129 manufactured by Epolin, Inc., MIR-101, MIR-111, MIR-121, MIR-102, MIR-105 manufactured by Midori Kagaku Co., Ltd., and the like.

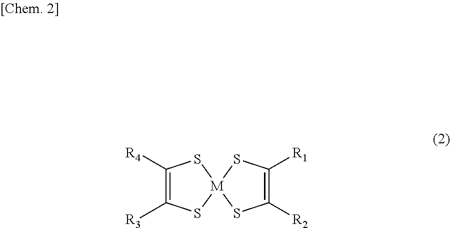

In the formula, R₁ to R₄ independently represent a phenyl group which may have a substituent or an alkyl group having 1 to 20 carbon atoms, and M represents a metal. M in the center of the dithiol metal complex-based pigment represents a metal such as nickel, platinum, vanadium, copper or molybdenum. Examples of the phenyl group having a substituent include a phenyl group substituted by 1 to 3 alkyl groups having 1 to 4 carbon atoms, a phenyl group substituted by 1 to 2 alkoxy groups having 1 to 4 carbon atoms or a phenyl group substituted by 1 to 5 halogen atoms such as chlorine or fluorine. S in the dithiol metal complex-based pigment may be Se, and it is also possible to use a diselenolene complex. The dithiol metal complex-based pigment represented by the formula (2) generally has excellent, heat resistance and has a wavelength of maximum absorption at 800 nm to 1100 nm depending on the type of the central metal or the substituent.

In the invention, furthermore, it is possible to use a dithdol metal complex-based pigment represented by the following formula (3). This compound is obtained by reacting a dithiolane compound and a base in an alcohol solvent so as to ionize the compound and the base, and adding an aqueous solution of a metal ion such as nickel chloride or vanadium chloride so as to react the ionized compound and the ionized base, and exhibits maximum absorption at 850 nm to 1300 nm. This compound is effective for preventing malfunction of remote controllers used in electronic devices for which absorption characteristics at a long wavelength are required, for example, a plasma display panel. In the invention, this compound can be solely used, and it is also possible to incorporate the compound into the dithiol metal complex-based pigment represented by the formula (2) and use the incorporated compound.

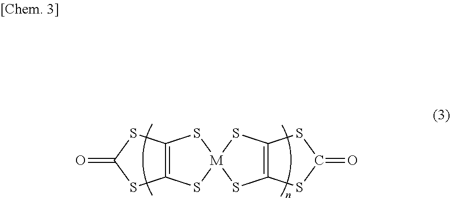

The central metal M is a transition metal such as nickel, platinum, palladium, copper or molybdenum, and n is an integer. Specifically, for example, when n=1, the following formula (4) is formed, and, when n=2, a compound represented by the following formula (5) is formed.

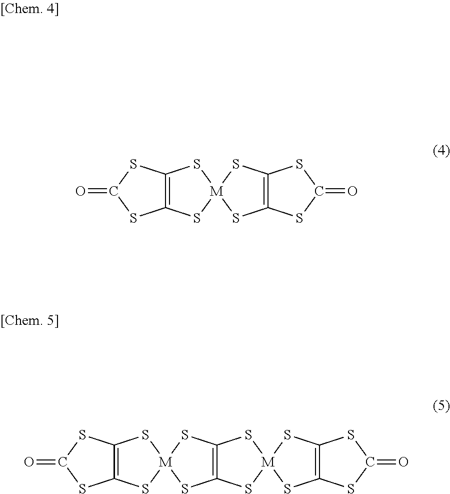

### EXAMPLES

Next, examples of the invention will, be described in detail together with. Comparative examples.

### Example 1

### Method for Manufacturing ITO Powder Having Modified Surfaces

First, an aqueous solution (50 mL) of indium chloride (InCl₃) containing In metal (18 g) and tin dichloride (SnCl₂.2H₂O, 3.6 g) were mixed, this mixed aqueous solution and an aqueous solution of ammonia (NH₃) were added dropwise to water (500 mL) at the same time, thereby adjusting the pH to 7. The components were reacted for 30 minutes in a state in which the temperature was set to 30° C. The generated precipitate which was a indium tin co-precipitated hydroxide was repeatedly washed slopewise using ion-exchanged water. When the resistivity of a supernatant liquid became 50000 Ω·cm or more, the supernatant liquid of the precipitate was removed, and a highly viscous slurry-form indium tin hydroxide was obtained. The indium tin hydroxide was dried at 110° C. for one right, then fired in the atmosphere at 550° C. for 3 hours, an aggregate was pulverized and raveled, thereby obtaining ITO powder. A pulverization treatment was carried out on the ITO powder using a jet mill (STARBURST MINI, a jet mill for small-volume production manufactured by Sugino Machine Limited). The ITO powder (25 g) was put and impregnated into a surface treatment agent obtained by mixing dehydrated ethanol and distilled water, then, put into a glass petal dish, and heated in a nitrogen gas atmosphere at 330° C. for 2 hours, thereby obtaining ITO powder having modified surfaces. The ITO powder was diluted using methyl ethyl ketone so that the content of the ITO powder became 30 mass %, thereby preparing an ITO dispersion liquid.

[Method for Manufacturing a Heat Ray Shielding Composition]

The dithiol metal complex pigment (Epolight3063 manufactured by Epolin, Inc., 0.05 mass %) represented by the above formula (2) and the ITO dispersion liquid (30 mass %) were mixed with methyl ethyl ketone (6995 mass), thereby manufacturing a heat ray shielding composition.

### Example 2

Instead of the dithiol metal complex pigment of Example 1, a diimonium-based pigment (CIR-1080 manufactured by Japan Carlit Co., Ltd.) was used as the near-infrared ray-absorbing pigment, and the diimonium-based pigment (0.2 mass %) and the ITO dispersion liquid (30 mass %) of Example 1 were mixed with methyl ethyl ketone (69.8 mass %), thereby manufacturing a heat ray shielding composition.

### Example 3

The dithiol metal, complex pigment (Epolight4129 manufactured by Epolin, Inc.) represented by the above formula (4) was used as the near-infrared ray-absorbing pigment, and the dithiol metal complex pigment (0.03 mass %) and the ITO dispersion liquid (30 mass %) of Example 1 were mixed with methyl ethyl ketone (69.97 mass %), thereby manufacturing a heat ray shielding composition.

### Example 4

The dithiol metal complex pigment (Epolight3063 manufactured by Epolin, Inc.) represented by the above formula (2) and the diimonium-based pigment (CIR-1080 manufactured by Japan Carlit Co., Ltd.) were used as the near-infrared ray-absorbing pigment, and the dithiol metal complex pigment (0.02 mass %), the diimonium-based pigment (0.2 mass %) and the ITO dispersion liquid (30 mass %) of Example 1 were mixed with methyl ethyl ketone (69.78 mass %), thereby manufacturing a heat ray shielding composition.

### Example 5

The dithiol metal complex pigment (Epolight3063 manufactured by Epolin, Inc.) represented by the above formula (2) and the dithiol metal complex pigment (Epolight4129 manufactured by Epolin, Inc.) represented by the above formula (4) were used as the near-infrared ray-absorbing pigment, and the dithiol metal complex pigment. (0.03 mass %) of the formula (2), the dithio metal complex pigment (0.03 mass %) of the formula (4) and the ITO dispersion liquid (30 mass %) of Example 1 were mixed with methyl ethyl ketone (69, 94 mass %), thereby manufacturing a heat ray shielding composition.

### Example 6

The diimonium-based pigment (CIR-1080 manufactured by Japan Carlit Co., Ltd.,) and the dithiol metal complex pigment (Epolight4129 manufactured by Epolin, Inc.) represented by the above formula (4) were used as the near-infrared ray-absorbing pigment, and the diimonium-based pigment (0.2 mass %), the dithiol metal complex pigment (0.02 mass %) of the formula (4) and the ITO dispersion liquid (30 mass %) of Example 1 were mixed with methyl ethyl ketone (69.78 mass %), thereby manufacturing a heat ray shielding composition.

### Example 7

The phthalocyanine-based pigment (PROJET-800NP manufactured by Avecia Biotechnology Inc.) represented by the above formula (1) was used as the near-infrared ray-absorbing pigment, and the phthalocyanine-based pigment (0.05 mass %) and the ITO dispersion liquid (30 mass %) of Example 1 were mixed with methyl ethyl ketone (69.5 mass %), thereby manufacturing a heat ray shielding composition.

### Example 8

The dithiol metal complex pigment (Epolight3063 manufactured by Epolin, Inc.) represented by the above formula (2), the diimonium-based pigment (CIR-1080 manufactured by Japan Carlit Co., Ltd.) and the dithiol metal complex pigment (Epolight4129 manufactured by Epolin, Inc.) represented by the above formula (4) were used as the near-infrared ray-absorbing pigment, and the dithiol metal complex pigment (0.02 mass %) of the formula (2), the diimonium-based pigment (0.2 mass %), the dithiol metal complex pigment (0.02 mass %) of the formula (4) and the ITO dispersion liquid (30 mass %) of Example 1 were mixed with methyl ethyl ketone (69.76 mass %), thereby manufacturing a heat ray shielding composition.

### Comparative Example 1

A precipitate obtained in the same manner as in Example 1, which was an indium tin co-precipitated hydroxide, was separated, the solid-liquid separated indium tin hydroxide was dried at 110° C. for one night, then, fired in the atmosphere at 550° C. for 3 hours, an aggregate was pulverized and raveled, thereby obtaining ITO powder. The ITO powder was put and impregnated into a surface treatment agent obtained by mixing dehydrated ethanol and distilled water (the mixing ratio is 5 parts by mass of distilled water to 95 parts by mass of ethanol), then, put into a glass petri dish, and heated in a nitrogen gas atmosphere at 330° C. for 2 hours, thereby obtaining ITO powder having modified surfaces. The ITO powder was diluted using methyl ethyl ketone so that the content of the ITO powder became 30 mass %, thereby preparing an ITO dispersion liquid. The ITO dispersion liquid was used as a heat ray shielding composition. The near-infrared ray-absorbing pigment was not included.

### Comparative Example 2

The ITO powder of Example 1 was diluted using methyl ethyl ketone so that the content of the ITO powder became 30 mass %, thereby preparing an ITO dispersion liquid. The ITO dispersion liquid was used as a heat ray shielding composition. The near-infrared ray-absorbing pigment was not included.

### Comparative Example 3

A heat ray shielding composition was manufactured in the same manner as in Example 1 except that the ITO powder of Comparative Example 1 was used instead of the ITO powder of Example 1.

### Comparative Example 4

A heat ray shielding composition was manufactured in the same manner as in Example 2 except that the ITO powder of Comparative Example 1 was used instead of the ITO powder of Example 1.

### Comparative Example 5

A heat ray shielding composition was manufactured in the same manner as in Example 3 except that the ITO powder of Comparative Example 1 was used instead of the ITO powder of Example 1.

### Comparative Example 6

A heat ray shielding composition was manufactured in the same manner as in Example 4 except that the ITO powder of Comparative Example 1 was used instead of the ITO powder of Example 1.

### Comparative Example 7

A heat ray shielding composition was manufactured in the same manner as in Example 5 except that the ITO powder of Comparative Example 1 was used instead of the ITO powder of Example 1.

### Comparative Example 8

A heat ray shielding composition was manufactured in the same manner as in Example 6 except that the ITO powder of Comparative Example 1 was used instead of the ITO powder of Example 1.

### Comparative Example 9

A heat ray shielding composition was manufactured in the same manner as in Example 7 except that the ITO powder of Comparative Example 1 was used instead of the ITO powder of Example 1.

<Comparison Test>

[Measurement of Spectral Characteristics]

The transmittances of visible light rays and near-infrared rays of the heat ray shielding compositions obtained in Examples 1 to 8 and Comparative Examples 1 to were measured. Specifically, the heat ray shielding compositions obtained in Examples 1 to 8 and Comparative Examples 1 to 9 were diluted using methyl ethyl ketone until the content of the ITO powder became 0.7 mass %. The diluted liquid was put into a glass cell having an optical path length of 1 mm, and the transmittance of visible light rays at 450 nm and the transmittances of near-infrared rays at 900 nm, 1100 nm and 1300 nm were measured according to the standard (JIS R 3216-1998) using a spectrophotometer (U-4000 manufactured by Hitachi, Ltd.), The transmittances of visible light rays and the transmittances of near-infrared rays of the respective heat ray shielding compositions obtained in Examples 1 to 8 and Comparative Examples 1 to 9 are described in Table 1.

[Computation of the Band Gap]

Each of the ITO powder (20 g) used in Examples 1 to and Comparative Examples 1 to 9 was put into and dispersed in a liquid mixture of distilled water (0.020 g), triethylene glycol-di-2-ethylhexanoate [3G] (23.8 g), dehydrated ethanol (2.1 g), phosphopolyester (1.0 g), 2-ethylhexanoic acid (2.0 g) and 2,4-pentanedione (0.5 g). Each of the prepared dispersion liquids was diluted using dehydrated ethanol so that the content of the ITO powder, which was a solid content, became 10 mass %. The diluted dispersion liquid was coated on a silica glass plate using spin coating so as to form a film, thereby obtaining a 0.2 μm-thick ITO film. The band gap of the ITO film was computed using the following method. The optical band gap was computed from the transmission spectrum of the ITO film using an integrating sphere-type spectrophotometer (U-4100 manufactured by Hitachi High-Technologies Corporation). The relation of the absorption coefficient α² with respect to photon energy (E=1240/wavelength (nm)) is plotted from a formula described below using the transmittance T of the ITO film. A portion of the curve that can be approximated using a straight line is extrapolated toward the small absorption side, and the optical band gap is computed from the photon energy at the intersection of the extrapolated line and the x axis. In the formula, d refers to the film thickness of the ITO film. The values of the band gaps of the respective ITO films obtained from the respective ITO powder of Examples 1 to 8 and Comparative Examples 1 to 9 are described in Table 1.

$$\begin{matrix}T = exp ( α d ) & ∴ {α}^{2} = {[ - \frac{ln ( T )}{d} ]}^{2}\end{matrix} \qquad [ Formula 1 ]$$

<Evaluation>

As described in Table 1, the heat ray shielding compositions of Comparative Examples 3 to 9 were insufficient and poor in terms of the transmittance of visible light rays and the cut rate of near-infrared rays. The heat ray shielding composition of Comparative Example 2 was favorable in terms of the transmittance of visible light rays, but insufficient and poor in terms of the cut rate of near-infrared rays. In contrast to the above, the heat ray shielding compositions of Examples 1 to 8 were high and favorable in terms of both the transmittance of visible light rays and the cut rate of near-infrared rays. Particularly, the cut rate of near-infrared rays by the heat ray shielding composition of Example 8 was the transmittances were 0.5% or less at wavelengths of 1100 nm and 1300 nm, which were most favorable. Meanwhile, the favorable transmittance of visible light rays means that the transmittance of visible light rays at a wavelength of 450 nm is 90% or more, and the poor transmittance of visible light rays means that the transmittance of visible light rays at a wavelength of 450 nm is less than 90%. In addition, the favorable cut rate of near-infrared rays means that the transmittances of near-infrared rays at wavelengths of 900 nm, 1100 nm and 1300 nm are 55% or less, 16.5% or less and 0.5% or less respectively, and all are satisfied, and the most favorable cut rate of near-infrared rays means that, among the favorable cut rates, furthermore, the transmittance of near-infrared rays at wavelengths of 900 nm, 1100 nm and 1300 nm are 35% or less, 1% or less and 0.5% or less respectively, and all are satisfied, and, furthermore, the poor cut rate of near-infrared rays means that the transmittances of near-infrared rays at wavelengths of 900 nm, 1100 nm and 1300 nm fail to satisfy any one of the above standards of favorable transmittances.

TABLE 1

| | | Transmittance (%) | | | | | |
|---|---|---|---|---|---|---|---|
| | | Visible | | | | Evaluation | |
| | Band | light rays | Near-infrared rays | | | Transmittance of | Cut rate of near- |
| | gap | (450 nm) | (900 nm) | (1100 nm) | (1300 nm) | visible light rays | infrared rays |
| Example 1 | 4.2 | 91.7 | 42.2 | 15.4 | 0.4 | Favorable | Favorable |
| Example 2 | 4.2 | 92.2 | 53.0 | 5.2 | 0.4 | Favorable | Favorable |
| Example 3 | 4.2 | 91.9 | 54.9 | 16.2 | 0.4 | Favorable | Favorable |
| Example 4 | 4.2 | 91.3 | 33.7 | 0.8 | 0.3 | Favorable | Favorable |
| Example 5 | 4.2 | 91.7 | 41.3 | 8.3 | 0.4 | Favorable | Favorable |
| Example 6 | 4.2 | 91.1 | 52.9 | 0.7 | 0.4 | Favorable | Favorable |
| Example 7 | 4.2 | 90.0 | 45.0 | 15.5 | 0.3 | Favorable | Favorable |
| Example 8 | 4.2 | 90.9 | 31.4 | 0.5 | 0.3 | Favorable | Most favorable |
| Comparative | 3.9 | 84.1 | 78.9 | 35.0 | 5.2 | Poor | Poor |
| Example 1 | | | | | | | |
| Comparative | 4.2 | 92.4 | 73.7 | 20.2 | 0.4 | Favorable | Poor |
| Example 2 | | | | | | | |
| Comparative | 3.9 | 82.4 | 57.3 | 30.1 | 5.0 | Poor | Poor |
| Example 3 | | | | | | | |
| Comparative | 3.9 | 83.6 | 68.0 | 12.9 | 5.0 | Poor | Poor |
| Example 4 | | | | | | | |
| Comparative | 3.9 | 81.7 | 70.1 | 32.0 | 4.9 | Poor | Poor |
| Example 5 | | | | | | | |
| Comparative | 3.9 | 82.1 | 49.3 | 10.6 | 4.9 | Poor | Poor |
| Example 6 | | | | | | | |
| Comparative | 3.9 | 81.9 | 54.8 | 23.4 | 4.8 | Poor | Poor |
| Example 7 | | | | | | | |
| Comparative | 3.9 | 82.7 | 67.1 | 8.0 | 4.8 | Poor | Poor |
| Example 8 | | | | | | | |
| Comparative | 3.9 | 81.3 | 47.0 | 4.9 | 4.8 | Poor | Poor |
| Example 9 | | | | | | | |

1. A heat ray shielding composition constituted by mixing one or two or more near-infrared ray-absorbing pigments selected from a group consisting of diimonium-based pigments, phthalocyanine-based pigments and dithiol metal complex pigments in a dispersion liquid formed by dispersing ITO powder in a range of 0.1 mass % to 50 mass in a range of 0.01 mass % to 0.5 mass % with respect to 100 mass % of the dispersion liquid,
wherein the ITO powder is used in manufacturing an ITO film which has a band gap in a range of 4.0 eV to 4.5 eV.

2. An ITO paint comprising:
the heat ray shielding composition according to claim 1;
a binder; and
a solvent.

3. A method for forming a heat ray shielding film by coating the ITO paint according to claim 2 on a transparent base material.

4. A method for forming a heat ray shielding film by uniformly mixing the heat ray shielding composition according to claim 1 with a film forming composition, and forming a film using a mixture.
